(19) United States
(12) Patent Application Publication
(10) Pub. No.: US 2024/0029520 A1
(43) Pub. Date: Jan. 25, 2024

(54) System and Method for a Nanosatellite Betting Game

(71) Applicant: Orient G Pte Ltd., Singapore (SG)

(72) Inventor: Francois Dubrulle, Singapore (SG)

(21) Appl. No.: 18/162,916

(22) Filed: Feb. 1, 2023

Related U.S. Application Data
(60) Provisional application No. 63/390,697, filed on Jul. 20, 2022.

(51) Int. Cl. G07F 17/32; B64G 1/10; B64G 1/40; G06Q 50/34; G06Q 20/38; G06Q 20/40

(52) U.S. Cl. CPC G07F 17/3288; G07F 17/3244; B64G 1/10; B64G 1/40; G06Q 50/34; G06Q 20/389; G06Q 20/40

(57) ABSTRACT

The invention of the present disclosure relates to a method for managing a space nanosatellite racing game for a race where a plurality of nanosatellites compete orbiting a celestial body. The method may include receiving a wager from a first participant, the wager including a wager amount and first participant predicted race finishing positions of the plurality of nanosatellites. The method may include receiving an influencing input from one or more of the first participant and a second participant, the influencing input including selected one or more of the plurality of nanosatellites and a corresponding influencing amount for each of the selected nanosatellites. The method may include transmitting a signal to activate thrusters for a predetermined time on each of the selected nanosatellites in response to the influencing input, thereby influencing the orbital progress of the selected nanosatellites.

### CROSS REFERENCE TO RELATED APPLICATIONS

This application claims the benefit of U.S. Provisional Patent Application Ser. No. 63/390,697, filed on Jul. 20, 2022, the contents of which are incorporated herein by reference.

### BACKGROUND OF THE INVENTION

There are myriad betting options available for individuals in a variety of industries, by way of example and not by limitation, such as sports betting, race car betting, horse betting, etc. This entails betting on either the sequence of elements, or on one specific element itself winning a race. This primarily occurs on the ground, oftentimes at live events where all bettors and spectators alike can view. The present system and method seek to expand the realm of betting by introducing the field of interstellar betting, particularly, betting on satellites.

There has yet to be substantial moves in the realm of interstellar betting, specifically through a plurality of nanosatellites with anomaly-like events that may influence the race. Communication occurs through any working and compatible communication device, and it utilizes signals transmitted via a predetermined network of ground stations to and from the identified satellites. Moreover, the present system and method provides an opportunity for bettors who correctly answer or guestimate a subsidiary question a chance to influence the race.

### SUMMARY OF THE INVENTION

The invention of the present disclosure relates to a space nanosatellite racing game.

Nanosatellites are satellites with mass between 1 kg to 10 kg. In the primary embodiment of the present system and methods, maximum weight 2.8 kg nanosatellites are utilized. These satellites traverse around the Earth in nearly-circular or circular orbits, because of the balance between both the escape pull, and the gravitational pulls upon launch or thrust. One positive measure in using these nanosatellites is that there is no debris left when they re-enter the atmosphere at the end of its operational life; this is due to the fact that atmospheric friction causes them to disintegrate altogether. These satellites are launched at low altitudes, typically between 380 and 420 km and at a speed of 7.67 km/s to limit their presence in outer space while sustaining them long enough for the interest of the game.

To start the race, satellites will be launched around the globe at the same altitude. This race may take place between eight satellites (or any other number of satellites) launched at a speed of 17,000 miles per hour in space. These satellites may be identical. The race starts once all satellites are released almost simultaneously in space then commissioned on their orbit shortly after.

An unlimited number of players can participate in the game. The game may be managed by one or more computers operating on a network, and players may communicate with the game via electronic communication devices. Once entering the game, each player may place a bet prior the race start via a website or application identifying the satellites ranking, from 1st to 8th, upon “arrival.”

Each player may be actively involved into the game and may influence the final order of arrival. With successive bets, each player may contribute to a collective set of bets to distantly “kick” the satellites of their choice, therefore accelerating or decelerating the satellites. There may be no restrictions to participate to the satellite race and everyone may play provided they reside in a place whereas regulation authorize them to, and if they legally hold a valid credit card and/or a valid cryptographic wallet.

This race may primarily include eight substantially identical satellites, each being a piece of hardware technology of less than three kilograms and launched together into orbit via conventional rockets (e.g., SpaceX/Falcon9). Each rocket may release one satellite aggregator (e.g., Momentus/Vigoride) that will jettison the eight satellites at the same time in space at a speed of 7.67 km/s (i.e., 27'608 km/h or 17'158 miles/h) kicking off the race between the eight satellites.

The race may be tracked by a network of ground stations that collect information from each satellite, as well as being capable to send “kick” instructions to each satellite. Each satellite may also be tracked independently by the United States Space Surveillance Network that detects, tracks, catalogs, and identifies artificial objects orbiting Earth and being under the responsibility of the United States Space Command and operated by the United States Space Force (www.space-track.org). The USSF shall deliver periodically independent information about each satellite in-orbit positioning.

Each satellite may orbit the Earth in about 92 minutes. Each player may interface with the race data via a web page and/or apps if regulation and commercial general conditions both authorize player to engage into the game. Verifiable race information may be frequently collected all over the race and distributed onto a blockchain via a Web3 application. Each race is deemed to last between one to four months in its time-dependent version.

To determine race winners, the following methodologies are employed. Upon game subscription, each player may list an order of arrival of all satellites (e.g., satellite #3 arrives first, satellite #6 arrives second, satellite #2 arrives third, etc.), hence betting one of the 40,320 potential outcomes. Prior to each race, the Race Organizer may pre-determine and inform players whether the race is time-dependent (i.e., end of race after thirty days) or signal-dependent (i.e., end of the race is declared when none of the satellite continues to be declared continuously working).

A satellite may be declared continuously working as long as it (1) can transmit or receive signals via a pre-designated ground station, or (2) it has not decayed through the dense layers of the atmosphere and burn altogether. Prior to any race, the race organizer may also decide any game variants, along with any prizes (e.g., betting on the first four satellites arriving, yielding 1,680 potential outcomes). The race organizer may declare a winner based on (1) its bet is identical to the satellite arrival ranking, and (2) as the case may be, other criteria (e.g., subsidiary question, like “what is the day satellite #4 will cease to work properly”.

The functionality of all satellites is as follows. Each satellite may be designed and manufactured according to the CubeSat standard (www CubeSat org) and will contemplate the below functions: one, a primary structure; two, a power subsystem than can deliver up to 10 W, using solar cells & battery system (e.g. Azur Space triple junctions Solar Cell Assembly P/N 3G30A coupled with GomSpace NanoPower P/N P31u); three, a telecom subsystem in S-Band, made of one patch antenna (e.g. ISIS S-Band antenna+GomSpace NanoCom P/N SR2000 Transceiver) transmitting GPS data to the ground station along with receiving ground instruction to kick the satellite upon order; four, an electric propulsion subsystem (e.g. Enpulsion Nano); five, an on-Board Computer (OBC) to diagnose and transmit information related to the health and functionalities of the spacecraft (e.g. GomSpace NanoMind A3200); six, a GPS chip (e.g. Novatel P/N OEM719), clear of export control, to transmit a precise positioning of the satellites in orbit; and seven, a bumper system made of rubber covers, qualified by NASA for space flight, to avoid any debris creation in case of shock between the satellites once in orbit. All satellite racers may be of identical 1.5 U form factor size with dimensions 15×10×10 (in cm) and will weight up to 2.8 kg.

To enter the game and interact with the race, regular players may enter the game prior to the start of the race by paying a race pass then place their bets prior to the race start. The Race Organizer may admit late players based on differentiated conditions (i.e., surcharge to the pass with a lesser price as the race arrival outcomes become lesser).

The ground segment is as follows. The Race Organizer may engage various third parties to rent an access to their ground station (e.g., in S-Band), with the following objectives. All continuously working satellites may have a minimum of one (1) contact a day, to receive instructions from the ground and to transmit satellite health status information as well as a precise positioning and a time stamp to the ground. Any primary ground station failing may be replaced by a secondary ground station to maintain the capability of a daily contact with each satellite all over the race.

When the satellite is launched into orbit, two steps are employed; the launch can be made with a commercial launcher (e.g., SpaceX/Falcon9), releasing a CubeSat aggregator (e.g., Momentus/Vigoride) containing the eight satellites. Then, by way of the CubeSat aggregator, releasing the eight satellites using a deployer system (e.g., “quad pack” made of four sleeves all simultaneously releasing two satellites mounted on each other).

The eight satellites may be released at 400 km altitude with the help of a soft spring located into each sleeve. Each sleeve may contain two satellites, one bottom, one top of the sleeve. Each satellite may be equipped with two soft springs on its bottom floor to ensure a minimum spacing between the satellites once released.

Upon the satellites release into orbit, they may initially form a tiny “cloud” of eight objects contained into a virtual sphere of an approximate radius of twenty meters. That sphere may grow larger with time as the satellites drift from each other and may reach a radius of one kilometer after one orbit and in a case whereas no “kick” is provided to any of the satellites. However, satellites trajectories and root-mean square velocities relative to the ground may remain approximately identical (identical sun synchronous orbit plane, altitude and speed reaching 17'000 mph). Their relative velocities may remain low (less than 10 cm per second). Each satellite attitude dynamics may vary, and they may begin progressively tumbling into space.

Another facet of the game is that players influence the race dynamics. Once the race has started, satellites may slowly drift away from each other on a quasi-inertial frame but in the same orbit plane and altitude. Actual order of satellites between each other may be expected to change unless each satellite becomes subject to a “kick” impulse using its propulsion subsystem onboard. Therefore, to entertain player's engagement, players can bet on a certain number of satellites via the web/app interface to “kick” them.

Bets may be collected daily and treated according to a set of mathematical principles.

The system defines tₘₐₓ being the maximum daily duration (in seconds) of impulse given to each satellite as it is “kicked”, tₘₐₓ is constant and given by a propulsion equation.

All satellites being equipped with the same propulsion subsystem, a “kick” transmitted by the ground station to each satellite shall be in a form of a command of satellite thruster firing at the appropriately determined duration.

All satellites are equipped with the same propulsion subsystem. A “kick” transmitted by the ground station to each satellite manifests in the form of a command of rapid satellite thruster firing as soon as instructions to “kick” have been transmitted. These kicks can be transmitted via one designated ground station to every selected satellite, provided that each kick may accelerate (50% probability) or decelerate the satellite (50% probability) depending on the orientation of the satellite at the time of boost, and in proportion of the intensity determined above. In that regard, a player may influence the race without intentionally choosing an outcome, i.e., by introducing a random factor to the race. An example of a possible propulsion system is the Enpulsion nano, which creates thrust by electrically accelerating ions as a propellant. These systems are of optimal weight and size for nanosatellite racing and provide thrust-vectored propulsion for spacecraft.

To measure relative position in orbit between satellites, a GPS chip comes into use. Satellite positioning may be given via its GPS chip installed onboard and may be transmitted to the ground stations via standard radiofrequency telecommunication system (typically in S-Band, X-Band, UHF or VHF Band). Those telecommunication data, compliant with National Marine Electronics Association (NMEA)/SGPGGA format, may serve to the position of the satellites and to a short-term extrapolation on its trajectory. These on-board data transmitted to the ground may be correlated with the TLEs provided by the USSF and positioning corrected or improved whenever necessary. Nanosatellite constellations enable the monitorization of asset groups all throughout the planet. Due to their logistic adeptness, they complement current network architectures and enable management such as geolocation and health status information.

Relative distances and ranking between satellites may be given via a “Pacer Point”. A Pacer Point is a virtual theoretical point orbiting the theoretical circular sun-synchronous orbit plane at 400 km regarding the true anomaly given ten minutes prior to the satellites are released into orbit. In other words, the epoch of the Pacer Point is t0 and epoch of the satellites released is t0+10 mn.

The race organizer may continuously calculate the relative distance between the Pacer Point to the satellites and may issue once (or several times) a day to the players the relative position of each satellite in the race (the closest to the Pacer Point being ranked first, and the most remote to the Pacer Point being ranked last), along with the independent satellite TLEs transmitted by the US SF. These sets of information may be available to players via a blockchain to ensure an independent verification of ranking information provided. In this embodiment, the betting information is stored as a unit of data on the blockchain, which acts as a digital ledger for gameplay. Players can view their betting history and actions on the blockchain as a recorded interaction on its digital ledger.

To establish the final ranking, the following methodologies are employed. In a signal-dependent race, the final ranking may be given successively by the satellite's signal ceasing to be transmitted to the ground station, either from an internal technical failure, or its reentry and destruction by the atmosphere friction. The first satellite to stop continuously working may be declared last and, in this example, will occupy rank 8. The second satellite to stop continuously working may occupy rank 7, etc. Satellites may be designed according to a Mean Time To Failure (MTTF) of two years, hence probability of failure of the satellite over a four-month race may be 15.3%. In case two or more satellites cease to transmit signals upon the same pass over a designated ground station, the final order between these satellites may be given in accordance with their last ranking via their actual positioning relative to the Pacer Point.

Despite quality of the design, manufacturing and satellite control, some unexpected events may impact equality of performance between satellites (fuel micro-leaks, thruster performance bias, privileged direction that biases kicks to a satellite, etc.). As a result, some of these potential conflicts and unrecorded events may require reasonable on-ground engineering management to maintain an equality of performance along the game.

In some instances, exceptional events occur (Act of God) that could oblige Race Organizer to terminate a race. In case of significant distortion in the normal course of a race between satellites, or in case of an unexpected early termination of the Race Organizer may set up a Race Committee that may settle any unforeseen cases based on individual or collective requests.

After a race, satellites will reenter the atmosphere and burn because of the atmosphere friction. Lifetime in orbit is multifactorial and may be difficult to predict with high precision, but initial modeling gives an in-orbit lifetime of 480 days+/−100 days in normal outer space solar or cosmic radiative activities. That uncertainty also serves a signal-dependent race that could last up to 18 months. No trace, and no pollution of debris whatsoever will remain from a space race.

The invention of the present disclosure will be described by way of the following non-limiting example.

Player 1 pays a Game Entry Fee (e.g. $100) and may promptly record on a ledger (made available by the Game Organizer) the ranking of each of the eight satellites in order, from 1 to 8 (i.e., in order of their arrival (whether time-dependent or event-dependent) satellite #3 is ranked first, satellite #7 is ranked second, satellite #2 is ranked third, etc.). Moreover, Player 1 may be required to answer a Supplemental question to decide who would win between all players having properly ranked in order all satellite. As a matter of example, such Supplemental question may be “What is the ranking of satellite #4 upon the sixth day of the race?” Player 1 may remain passive and wait for the racing arrival, expecting the actual ranking is the same, along with properly answering to the Supplemental question.

Significant to note is that the probability of finding the correct ranking as well as the Supplemental question is determined by 8×8!=322,560, i.e., in case of one million players, expected number of winners may be rounded (1,000,000/322,560)=3.

Unlike Player 1, Player 2 may wish to influence the race in fueling “kicks” (in form of thruster “boosts”) to satellites of its choosing. Every day, and as long as the race continues (whether time-dependent or event-dependent, being of several weeks), the Game Organizer may authorize Player 2 to choose one or more satellites amongst the eight racing and give each of them “fuel credits”, each fuel credit being charged one US dollar (US$1).

For instance, on Day 3 of the race, Player 2 decides to give fuel credits to satellites in accordance with the below table:

| Satellite Designation | Fuel Credit granted by Player 2 |
|---|---|
| 1 | 0 |
| 2 | 3 |
| 3 | 10 |
| 4 | 0 |
| 5 | 4 |
| 6 | 2 |
| 7 | 1 |
| 8 | 0 |
| Total Fuel Credits | 20 |

Therefore, on Day 3 of the race, Player 2 will be charged US$20 for 20 credits at $1/credit.

At the end of Day 3, all Fuel Credits of all players (including Player 2) are aggregated as per the below table:

| Satellite | Fuel Credit granted | Normative Fuel Credit | Boost (in |
|---|---|---|---|
| Designation | by all players | each Satellite (1) | seconds) (2) |
| 1 | 8,400 | 0.427 | 8.5 |
| 2 | 3,412 | 0.173 | 3.5 |
| 3 | 10,902 | 0.554 | 11.1 |
| 4 | 3,523 | 0.179 | 3.6 |
| 5 | 7,321 | 0.372 | 7.4 |
| 6 | 2,434 | 0.124 | 2.5 |
| 7 | 19,675 | 1.000 | 20.0 |
| 8 | 4,735 | 0.241 | 4.8 |

Each fuel credit may be divided by the highest fuel credit to one satellite, in the table above, it showcases Satellite #7 with 19,675. The “boost” to each Satellite is the Normative Fuel Credit, multiplied by tₘₐₓ whereas tₘₐₓ is 20 seconds (as an example)

A Boost corresponds to the variation of kinetic energy transmitted to each satellite by its own thruster, and all listed Boost values are sent in a form of a radiofrequency telecommand to each satellite racing, each Boost being pro-rated to the time of thruster firing (in seconds) of each designated satellite. The contribution to the boost provided by Player 2 is combined with boosts provided by other players to collectively contribute to boost satellites as shown above. Each Boost contributes to either the acceleration (50% chance) or to the deceleration (50% chance) of each satellite, depending on the orientation of the satellite at the time of boost, such probability being out of control of stakeholders, including the Game Organizer. Player 2 may continue to contribute to fuel-credit any satellite on any day of the race, until the race end.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 depicts the satellite functionalities of the present invention.

FIG. 2 details the process to enter a race.

FIG. 3 is a diagram showcasing how players may be asked supplemental questions or offered fuel credits to influence the race.

FIG. 4 is a flow diagram depicting how players can win by way of betting or subsidiary questions.

FIG. 5 is a visual overview of the present invention's ecosystem, featuring the launch, satellites, ground control, health status information and “kicks” radiofrequency commands.

FIG. 6 is an overview of the present invention's option to “fuel kicks” or provide a boost to the desired satellites by way of fuel credits.

FIG. 7 is a visual overview of the present invention's wireless communication method that allows for real-time updates to be provided to players.

FIG. 8 is a diagram depicting the present invention's web service infrastructure.

FIG. 9 is a depiction of the present invention's web services infrastructure, as well as the components of an exemplary operating environment in which embodiments of the present invention may be implemented.

FIG. 10 is an illustration of a multi-server room and the various locations in which other pertinent server rooms may exist.

FIG. 11 is a diagram outlining the web services incorporated with server-client communication.

FIG. 12 is a diagram of the flow of access between the present invention and the web services client via cloud software tools.

FIG. 13 is a diagram of an example of the cloud storage organization in which the web services accesses and retrieves user data as objects in buckets within a cloud storage space.

### DETAILED DESCRIPTION OF THE PREFERRED EMBODIMENT

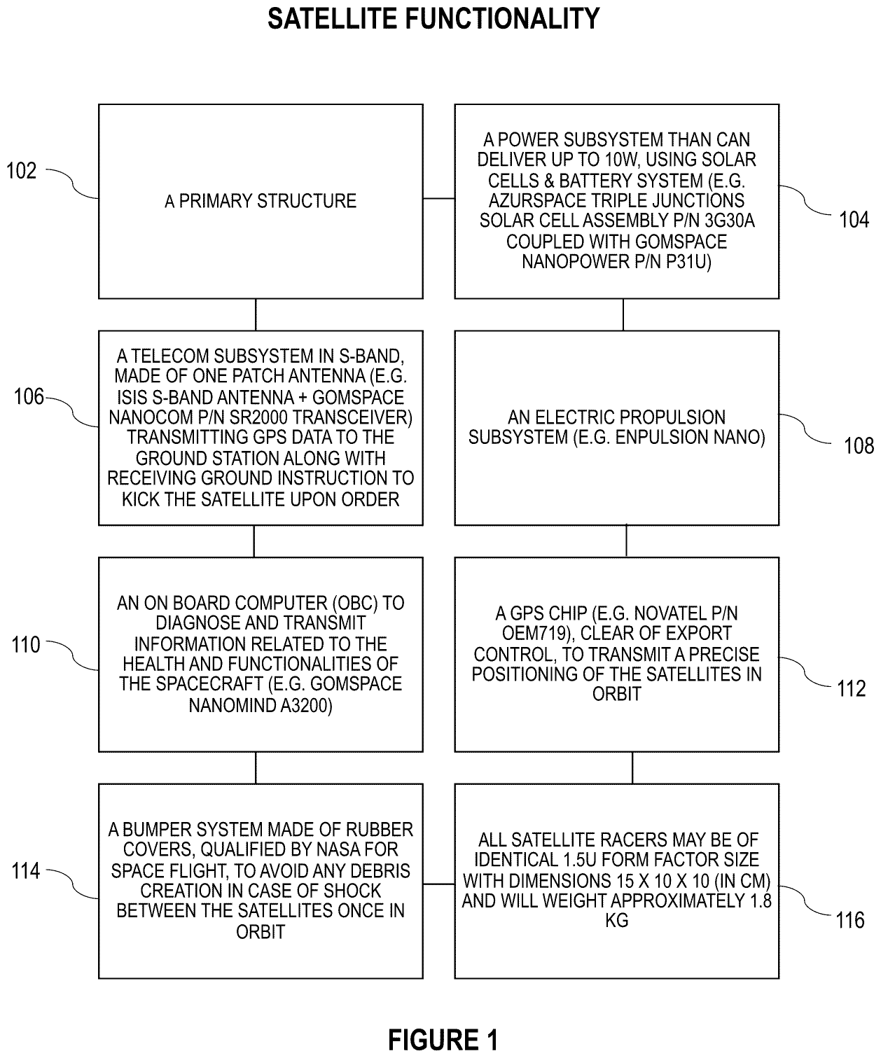

FIG. 1 depicts the satellite functionalities of the present invention. The satellite may include a primary structure 102 as well as a power subsystem that may deliver approximately 10 watts, utilizing solar cells and a battery system 104 which, by way of example and not limitation, may utilize an Azur Space triple junction solar cell assembly P/N 3G30A, paired with GomSpace NanoPower P/N P31U. Additionally, it may feature a telecom subsystem in S-band, made of one patch of antennae, for example, an Isis S-Band antenna with a GomSpace NanoCom P/N SR2000 transceiver to transmit GPS data to the ground station, along with ground instructions to kick the satellite upon completion of an order of fuel credits 106. It will also feature an electric propulsion subsystem, such as an Enpulsion nano 108 which creates thrust by electrically accelerating ions as propellant, and an on-board computer (OBC) which diagnoses and transmit pertinent satellite health information, as well as the functionalities of the spacecraft 110. This can be executed with the GomSpace NanoMind A3200. The present system and method also employ a GPS chip 112 which transmits the precise location of the satellites in orbit. A bumper system 114 is also utilized to avoid the creation of debris in case of any shock contact between orbiting satellites, and is made of rubber covers, qualified by NASA for space flight. All satellite racers 116 may be of the identical 1.5 U form factor size with dimensions of 15×10×10 in CM, and will weight up to 2.8 kg, but this may differ based on evolving technologies.

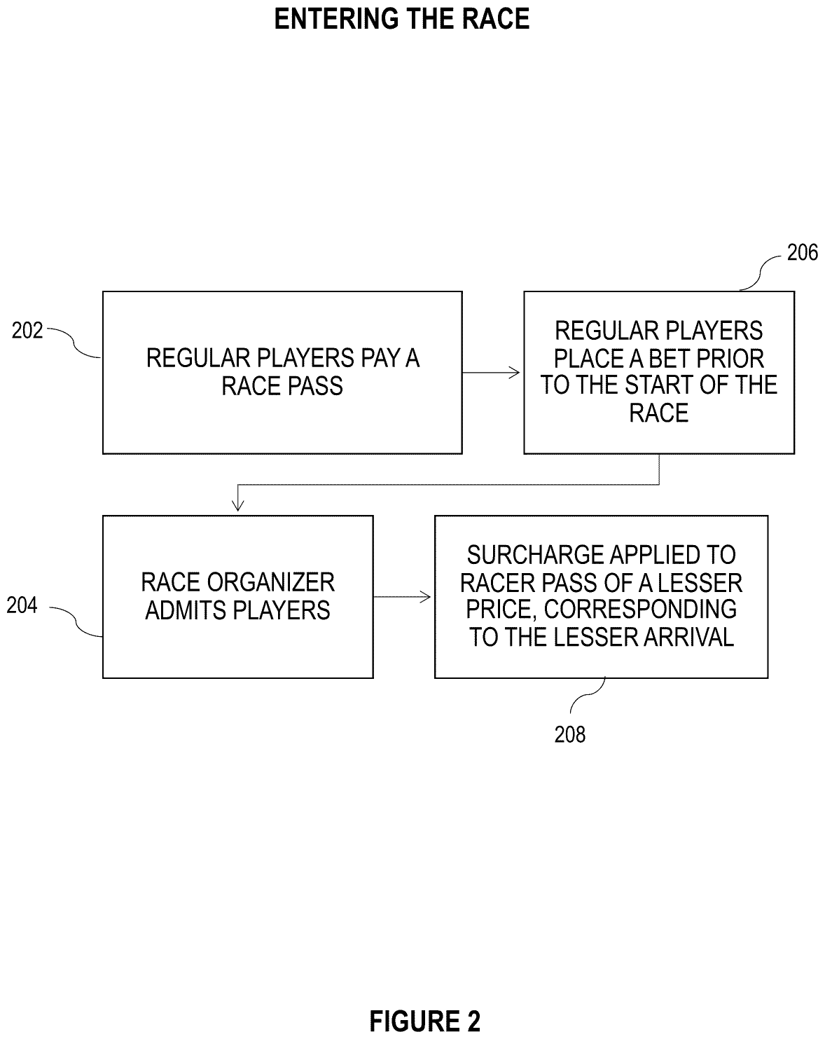

FIG. 2 details the process to enter a race. Regular players may play a race pass 202 and bet prior to the start of the race 206. Then, the race organizer admits the players 204 and a surcharge is applied to a race pass of a lesser price, which corresponds to the lesser arrival 208.

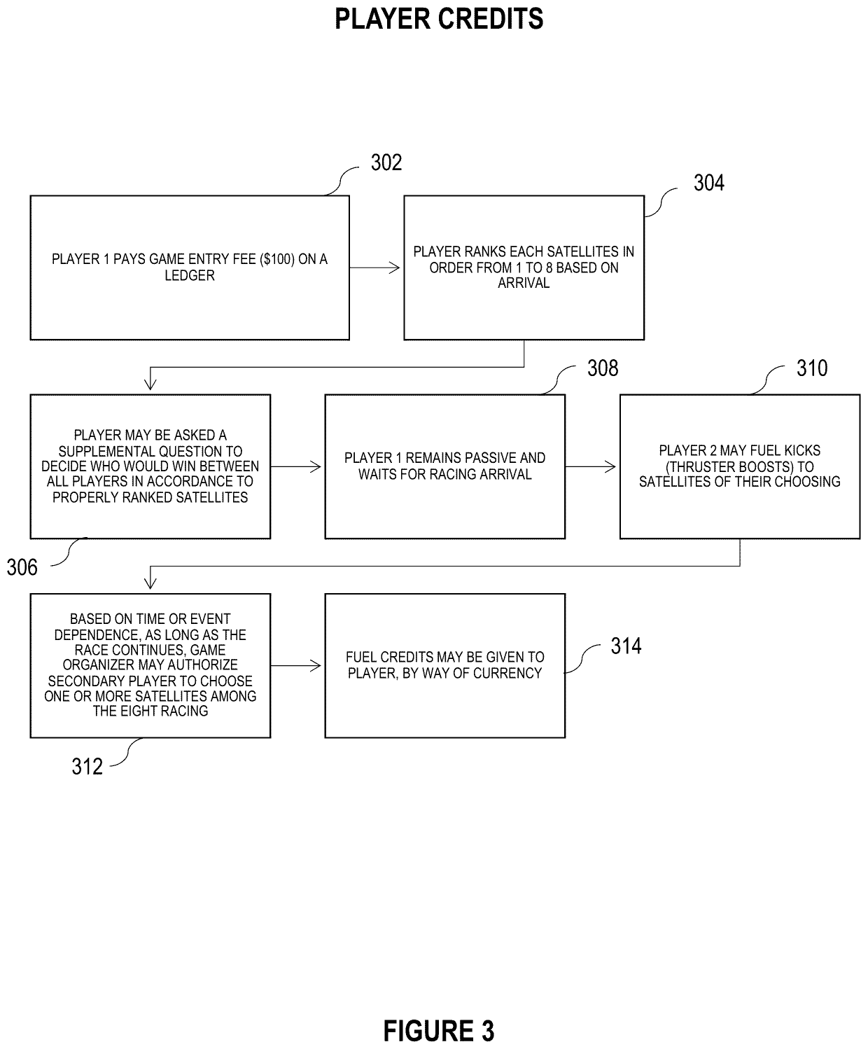

FIG. 3 is a diagram showcasing how players may be asked supplemental questions or offered fuel credits to influence the race. In this example, Player 1 pays their game entry fee on a digital ledger, or blockchain 302. They may view all their recorded transactions accordingly. The player then ranks each satellite in order from 1 to 8 based on their perceived arrival 304. A player may be asked a supplemental question to decide who would win between all players in accordance with the properly ranked satellites 306. While player 1 remains passive and waits for racing arrivals 308, player 2 has the option of fueling kicks or thruster boosts to satellites of their choosing, dependent on the organizer 310. Based on time or event dependence, which is in the control of the game organizer, if the race continues, the game organizer may authorize player 2 to choose one or more satellites among the eight racing to boost 312. To do so, however, player 2 must purchase fuel credits 314.

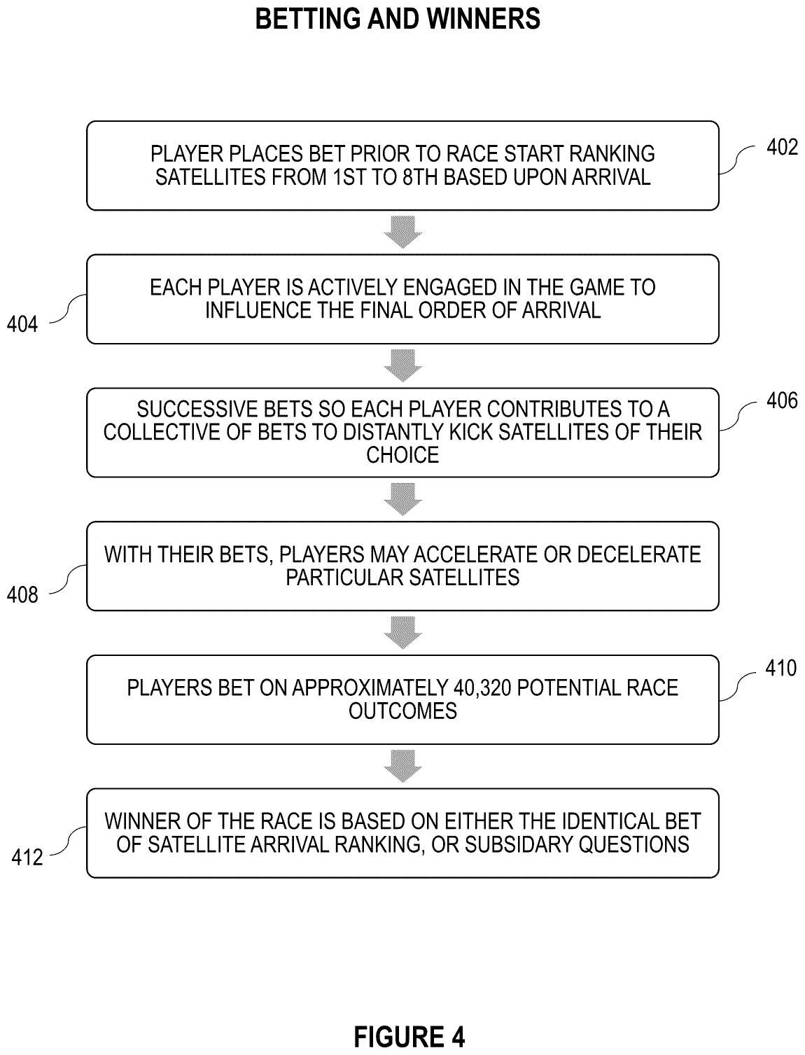

FIG. 4 is a flow diagram depicting how players can win by way of betting or subsidiary questions. The player may place bets prior to the start of the race ranking arrival 402 and each player engaged in the game influences the final order of arrival 404. The system and method entail allowing successive bets so that each player can contribute to a collective of bets and kick satellites of their choosing 406. Players bets will decelerate or accelerate satellites 408. Players bet primarily on 40,320 potential racing outcomes 410 and can employ equations and probability to justify their engagement within the game. The winner of the race is determined by the identical bet of satellite arrival ranking, or subsidiary questions 412.

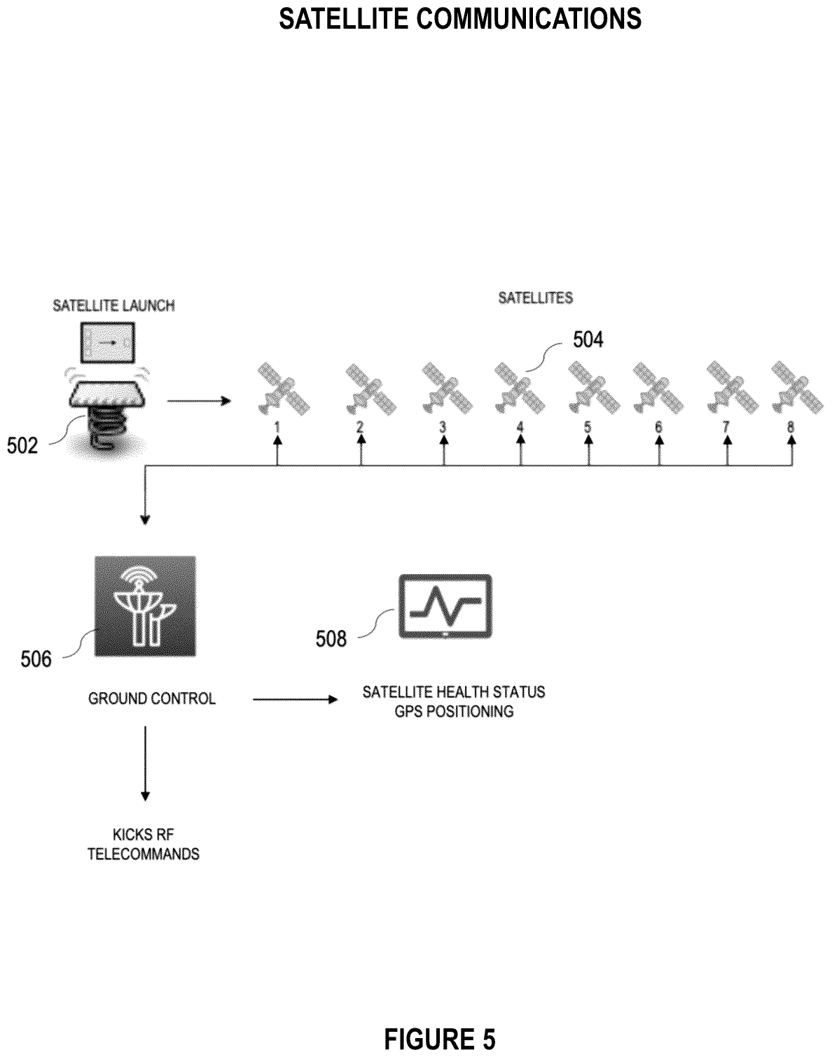

FIG. 5 is a visual overview of the present invention's ecosystem, featuring the launch, satellites, ground control, health status information (including GPS signals) and “kicks” telecommand orders. The satellite 504 can be launched by way of a commercial launcher 502 such as a SpaceX/Falcon 9 launcher, releasing a CubeSat aggregator containing the eight satellites 504, or using a deployer system such as a quad pack. The rocket may release one satellite aggregator that will thrust the eight satellites 504 simultaneously at 7.67 km/s, thereby kicking off the race. The satellites contain GPS signals allowing its tracking 510 and carry satellite health status information 508 that is sent to ground control 506.

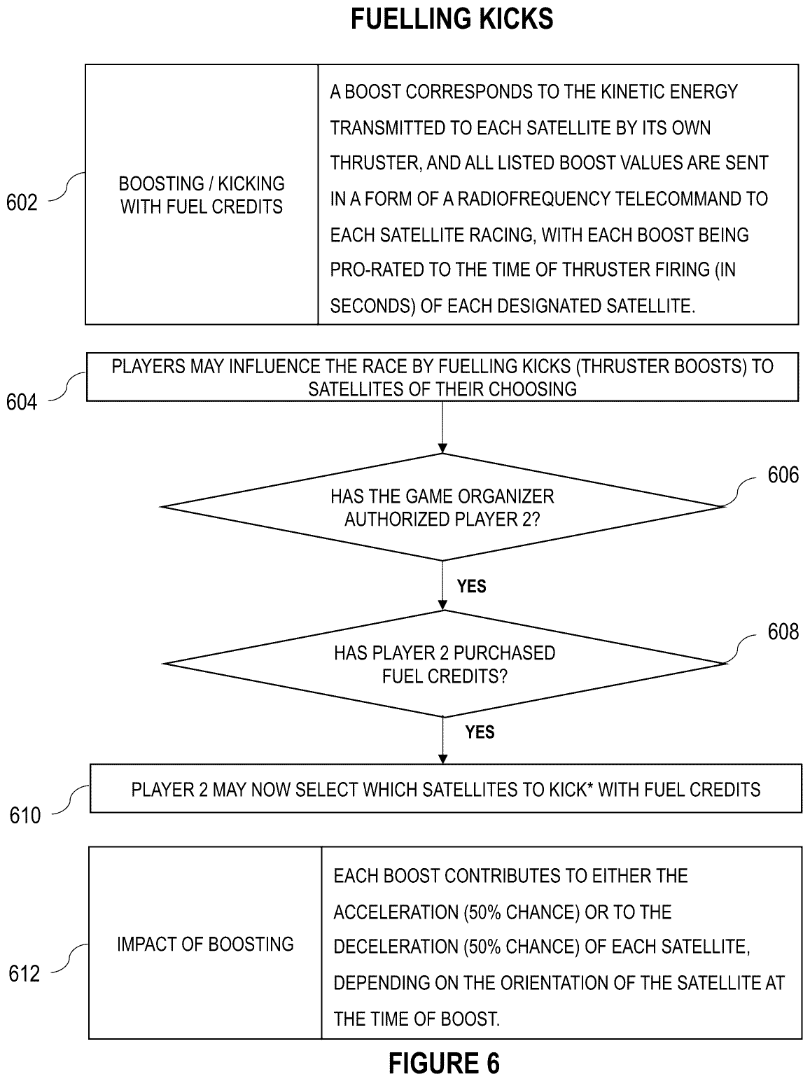

FIG. 6 is an overview of the present invention's option to “fuel kicks” or provide a boost to the desired satellites by way of fuel credits. “Boosting” and “kicking” is essentially the variation of kinetic energy that is transmitted to each satellite by its own fixed thruster, which are then sent in the form of a radiofrequency telecommand to each racing satellite, with each boost being pro-rated to the time of the thruster firing 602. Players may influence the race by fueling thruster boosts and kicks to satellites of their choosing 604. If the game organizer authorizes a player 606, and if the player has purchased fuel credits 608 then the player may now select which satellites to “kick”, accelerate or decelerate with fuel credits 610. Each boost contributes to the acceleration or deceleration (with a 50% chance, each) 612 of each desired satellite, depending on the orientation of the satellite at the time of the boost.

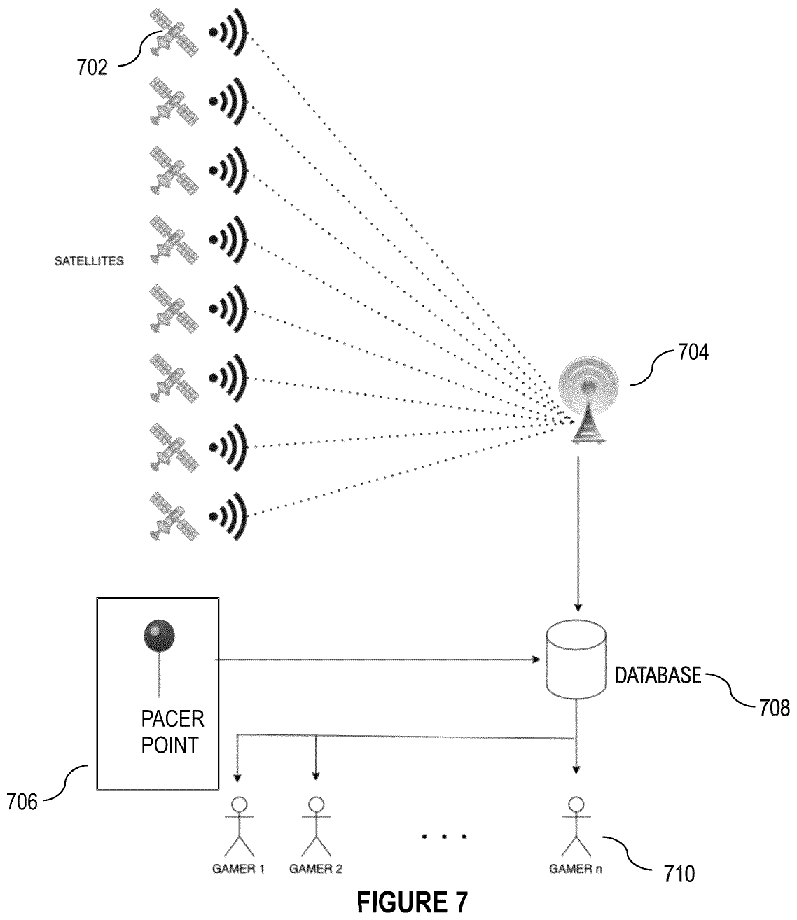

FIG. 7 is a visual overview of the present invention's communication and data processing system that allows for real-time updates to be provided to players. Each nanosatellite 702 communicates with the game organizer or ground control 704 (as also shown in FIG. 5) via standard radiofrequency telecommunication system (typically S-Band). Data sent by each nanosatellite via said standard telecommunication system will be sent to a secure database 708 and used by the game organizer to calculate the relative distances and therefore relative positions in the race of each satellite. This information then becomes available to players 710 via a blockchain to ensure an independent verification of ranking information.

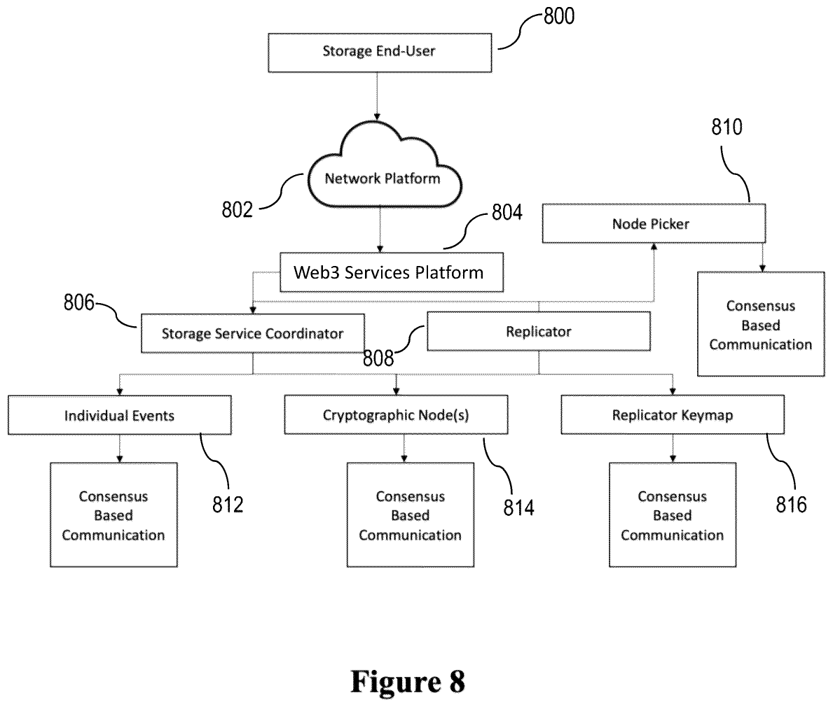

FIG. 8 is a diagram showing the communication between the storage end users, the network platform and the various elements that help effectuate operations. The storage end user 800 communicates and relays various pertinent bits of data to the network platform 802. The network platform operates on a web3 service platform 804 which features a storage service coordinator 806 and replicator 808. Each of these services utilize a node picker 810 which helps establish consensus-based communication. The storage service coordinator maintains and records individual events 812 and cryptographic nodes 814, or keys that are used for operations. The replicator has its own keymap 816 which generates consensus-based communication, alongside the cryptographic nodes and individual events.

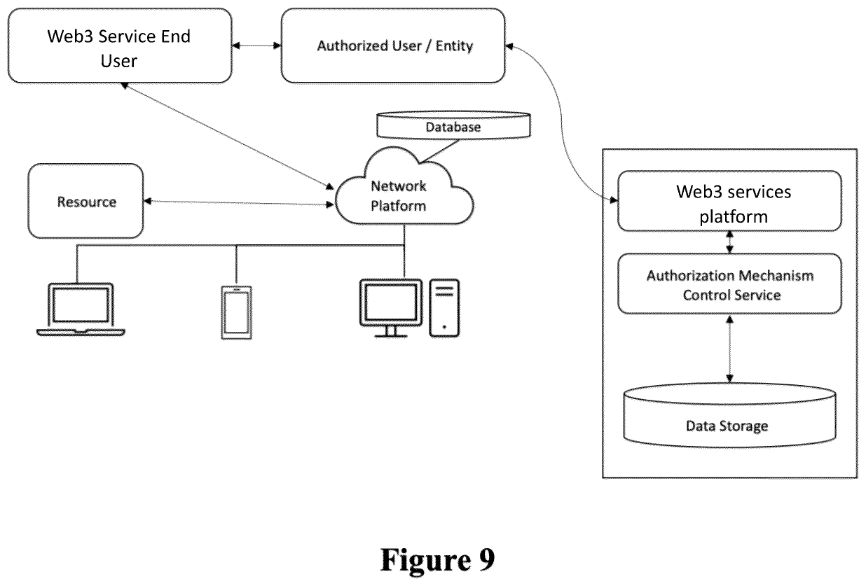

FIG. 9 is a diagram showing the web services of the present invention and system. The present invention and system are all components of an exemplary operating environment in which embodiments of the present invention may be implemented. The system can include one or more user computers, computing devices, or processing devices which can be used to operate a client, such as a dedicated application, web browser, etc. The user computers can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network (e.g., the network described below) and/or displaying and navigating Web pages or other types of electronic documents. Although the exemplary system is shown with four user computers, any number of user computers may be supported.

In most embodiments, the system includes some type of network. The network can be any type of network familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a web3 server, application server, etc. Such servers may be used to process requests from user computers. The applications can also include any number of applications for controlling access to resources of the servers.

The Web3 server can be running an operating system including any of those discussed above, as well as any commercially available server operating systems. The Web3 server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more Web3 applications. The Web3 application may be implemented as one or more scripts or programs written in any programming language, such as Java®, C, C#, or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer.

End users, or users that are viewing and using the network platform, all contribute data to the cloud. A web service platform helps secure that data and maintain the service's functionalities. Only authorized users and entities can authorize or unauthorize content and monitor data stored within the web service. The platform's web services help maintain the operations of elements managed by the storage system.

The system may also include one or more databases. The database(s) may reside in a variety of locations. By way of example, a database 620 may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10 g, that is adapted to store, update, and retrieve data in response to SQL-formatted commands.

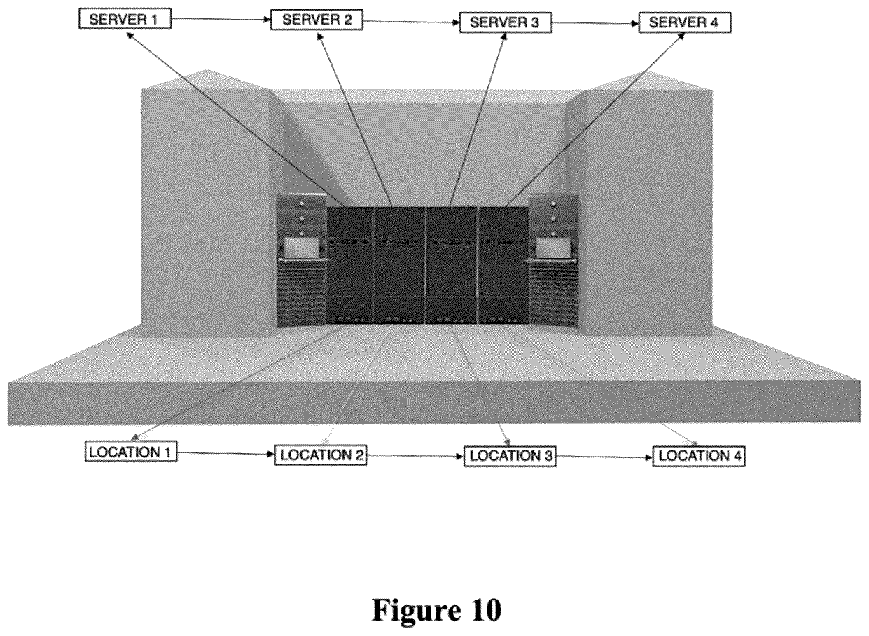

FIG. 10 is an illustration of server-to-server connections, within a server room and to other sever room locations. The web server undergoes an initialization process and features a database of wireless network data. Dependent on the service requested, the data may undergo processing. The servers actively attempt to retrieve the appropriate data to provide user input. Data may then be formatted, and with the appropriate authorizations, saved or restructured.

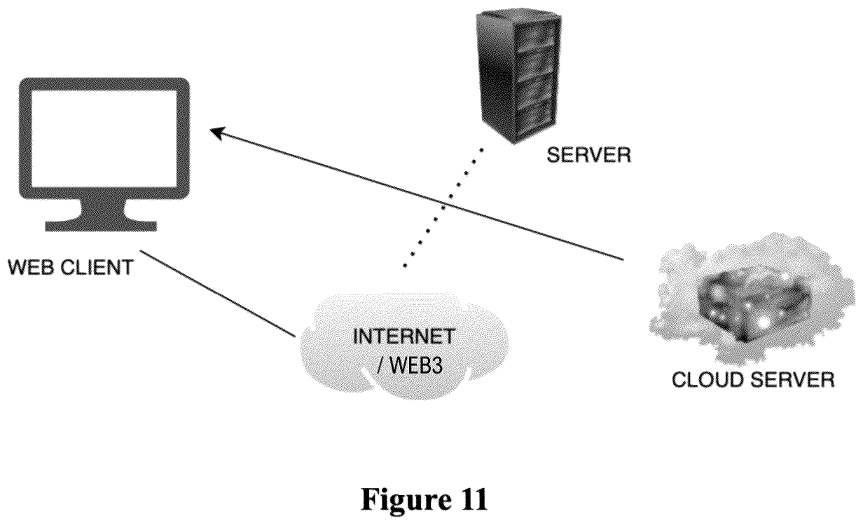

FIG. 11 is a diagram outlining the role of web services in the present invention. In accordance with the preferred embodiment, a web client interacts with the server ecosystem by way of a service connection, such as the internet, which then distributes data and pertinent information such as the web service platform to the cloud server and preliminary servers. This allows for data to be streamlined between the client and the server as well as cloud servers and other database systems. Communication between web services may be completed via Simple Object Access Protocol (SOAP) which allows multiple web service applications to communicate rapidly and efficiently and to provide data to the web client.

The infrastructure of the present invention also allows for the use of web services that enable interaction with and storage of data across devices. Specifically, these web services can allow for the use of cloud software tools and cloud-based data storage. Cloud software tools can be used to allow for increased user authentication and authorization checkpoints for data accessed between parties. The web service software aids in the transmission of data between entities while still maintaining secure access restrictions preventing any unauthorized access to the cloud data.

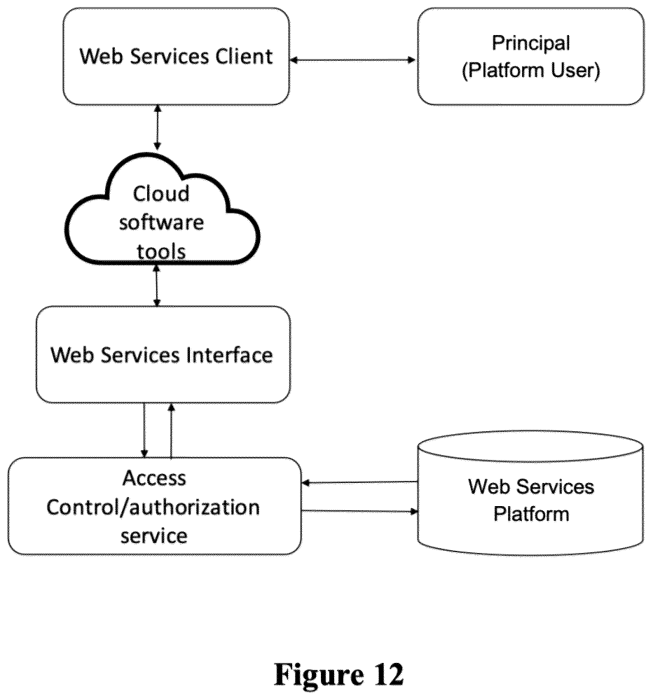

FIG. 12 is a diagram of the flow of access between the present invention and the web services client via cloud software tools. The principal or system user accesses the web services client, which then transmits data via cloud software tools to the web services interface. Access control and authorization acts as a layer in order to access the web services platform by way of the web services interface.

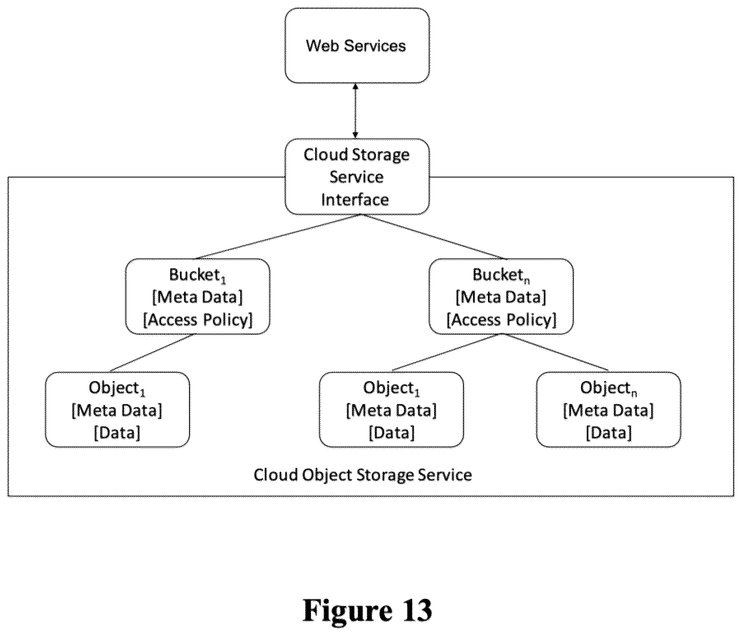

FIG. 13 is a diagram of an example of the cloud storage organization in which the web services accesses and retrieves user data as objects in buckets within a cloud storage space. The cloud storage service is a means of storing and protecting any amount of data for a range of use cases. A bucket is a container for objects stored in the cloud storage service, and objects consist of object data and metadata. The metadata is a set of name-value pairs that describe the object. These pairs include some default metadata, such as the date last modified, and standard HTTP metadata, such as Content-Type. You can also specify custom metadata at the time that the object is stored. Web services provide access to and from the cloud object storage service via the cloud storage service interface.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A method for managing a space nanosatellite racing game for a race where a plurality of nanosatellites compete orbiting a celestial body, the method comprising:
receiving a wager from a first participant, the wager comprising a wager amount and first participant predicted race finishing positions of the plurality of nanosatellites;
receiving an influencing input from one of the first participant and a second participant, the influencing input comprising selected one or more of the plurality of nanosatellites and a corresponding influencing amount for each of the selected nanosatellites;
transmitting a signal to activate thrusters for a predetermined time on each of the selected nanosatellites in response to the influencing input, thereby influencing the orbital progress of the selected nanosatellites;
paying, after a predetermined time or event indicating completion of the race, an amount to the first participant based on at least the first participant predicted race finishing positions and actual finishing positions of the plurality of nanosatellites.

2. The method according to claim 1, wherein the nanosatellites relay GPS data, by way of a transceiver, to a ground station.

3. The method according to claim 1, wherein the thrusters accelerate or decelerate the selected nanosatellites depending on an orientation of the identified nanosatellites when the thrusters are engaged.

4. The method according to claim 1, wherein the influencing amount comprises a fee in currency based on the number of selected nanosatellites and wherein a nanosatellite may be selected more than once in each influencing input.

5. The method according to claim 1, wherein the wager further comprises a response to a supplemental question to act as a tiebreaker.

6. The method according to claim 1, wherein one or more of the wager amount and the influencing amount comprise a payment in currency.

7. A system for managing a space nanosatellite racing game for a race where a plurality of nanosatellites compete orbiting a celestial body, the system comprising:
a wager received from a first participant, the wager comprising a wager amount and first participant predicted race finishing positions of the plurality of nanosatellites;
an influencing input from one or more of the first participant and a second participant, the influencing input comprising selected one or more of the plurality of nanosatellites and a corresponding influencing amount for each of the selected nanosatellites;
a signal to activate thrusters for a predetermined time on each of the selected nanosatellites in response to the influencing input, thereby influencing the orbital progress of the selected nanosatellites; and
a payment, after a predetermined time or event indicating completion of the race, of an amount to the first participant based on at least the first participant predicted race finishing positions and actual finishing positions of the plurality of nanosatellites.

8. The system according to claim 7, wherein the plurality of nanosatellites relay GPS data, by way of a transceiver, to a ground station.

9. The system according to claim 7, wherein the thrusters accelerate or decelerate the selected nanosatellites depending on an orientation of the selected nanosatellites when the thrusters are engaged.

10. The system according to claim 7, wherein the influencing amount comprises a fee in currency based on the number of selected nanosatellites and wherein a nanosatellite may be selected more than once in each influencing input.

11. The system according to claim 7, wherein the wager further comprises a response to a supplemental question to act as a tiebreaker.

12. The method according to claim 7, wherein one or more of the wager amount and the influencing amount comprise a payment in currency.

13. A system for managing and ranking space nanosatellites in a racing game for a race where a plurality of nanosatellites compete orbiting a celestial body, the system comprising:
a nanosatellite racing game with a game entry fee recorded on a digital ledger, enabling web-services with server-client communication;
a game organizer that authorizes a fuel credit to players using real currency;
players ranking and betting on nanosatellites in a signal-dependent race;
wherein a signal-dependent race provides a set of final rankings given successively by way of a satellite signals transmitted to a ground station, and;
wherein boosts, corresponding to the variation of kinetic energy transmitted, are given to thrust and influence final rankings by way of fuel credits; and
a blockchain-based system for calculating, recording, collecting, and securing nanosatellite race data.

14. The system according to claim 13, further comprising said nanosatellites providing health status and diagnostics that influence rankings after launch.

15. The system according to claim 13, wherein said boosts and variations of kinetic energy transmitted are sent in the form of a radiofrequency telecommand to each nanosatellite racing.

16. The system according to claim 13, wherein said web services feature Web3 servers that secure transmission data, and monitor said data with verified ranking information, via a Web3 application.

17. The system according to claim 13, further comprising said blockchain-based system that records nanosatellite and transmission data, alongside betting information and transaction data on said digital ledger.
